(19) United States
(12) Patent Application Publication
(10) Pub. No.: US 2020/0217676 A1
(43) Pub. Date: Jul. 9, 2020

(54) Percentage based route prediction software core for triple mode triple criterion travel combinations

(71) Applicant: KALYANARAMAN B, DINDIGUL (IN)

(72) Inventor: KALYANARAMAN B, DINDIGUL (IN)

(21) Appl. No.: 16/240,721

(22) Filed: Jan. 5, 2019

(51) Int. Cl. G01C 21/34; G06Q 10/04; G01C 21/20

(52) U.S. Cl. CPC G01C 21/3453; G01C 21/20; G06Q 10/047

(57) ABSTRACT

A computer program, software core for the route prediction of the particular need of traveler in various important parameters is implemented. The combination between any triple mode and triple criteria that is distance, time and cost are included. The traveler selection choice may be any one of the above forty nine combinations. The selection decision among the multiple transient routes is done on percentage basis at each level. The final route is the optimal result according to the traveler required combination of modes and criteria.

### BACKGROUND

This invention is a software core for predicting route between source and destination by involving any one, two or three modes and three criterions. The final result combines the individual results between these modes and combinations by percentage basis and produces the optimal result.

The olden and existing systems compute the route for the mode combinations and for one or two criterions and not for criteria combinations. They are only structured procedures or software that cannot be tailored to the various travel system of modes. In this growing world the traveler may be for various purposes like tourist, treatment, research, business etc., there they need more particular choices between the modes and criterions. So, the further enhancement of the existing route prediction methods needed enlarging more combinations.

The importance for the criteria combinations were not focused in existing systems. The needed criteria combinations between distances, time and cost multiplexes the output possibilities with mode combinations. So, the output will be more precise, convenient and optimal for the travelers.

### SUMMARY

The method, program, software core computes the transient routes and modes for the ultimate route between the source and destination. Source, destination, mode combination, criteria combination, departure time, required class, required number of seats are retrieved from the user. The final route is predicted step by step between the required modes and criterions by combining the intermediate results by percentage benefit basis. The database design is provided in this invention such a way that suits for the software core. The presentation layer may be formed on this software core according to the designer's convenient. The data base can be maintained either online or offline.

### DETAILED DESCRIPTION

The software reads the source, destination and the departure time. In addition to that the traveler can select one of the seven mode combinations and one of seven criteria combinations. There are forty nine possibilities of combinations of these two parameters mode and criteria. The traveler can also select the ‘class’ they want to travel and the required number of seats in that class.

The embodiment of this invention is producing the cumulative result of all the above said details, that is for mode combinations of the criteria combinations for the required class and seat. In the software there are seven distinct operations for finding the result. They are for the seven criterion combinations between distance, time and cost for any mode combinations.

After selecting the required parameters by the traveler, the software computes the transient routes up to the required level. The level increases according to the requirement of plurality of above said criterions. First the transient route between the source and destination are computed individually for each criterion. Then the common nodes are taken account from these individual routes. These individual routes are compared in percentage basis between each common nodes and one of the route is selected. Similarly the final route is computed by combing all selected routes between the common nodes.

The final result is a optimal one for the traveler required parameters of modes, criterions, departure time, class and availability.

This software core translates and computes the time in GMT format. By comparing the departure time and required combinations the route is traversed towards the destination. The modules of the software compute the routes for various criterions separately. The data base design contains separate tables for all the required parameters for all mode combinations. The route for individual criteria is computed in separate modules. Suppose the requirement is for more than one criterion the routes are computed separately for all the required criterions. These results are compared in percentage basis between common nodes of these routes and the final route is predicted if the criteria requirement is for more than one criteria. The software core computes the output for not only the best three criterions ie., distance, time and cost but also for the seven possible combinations of all the above three.

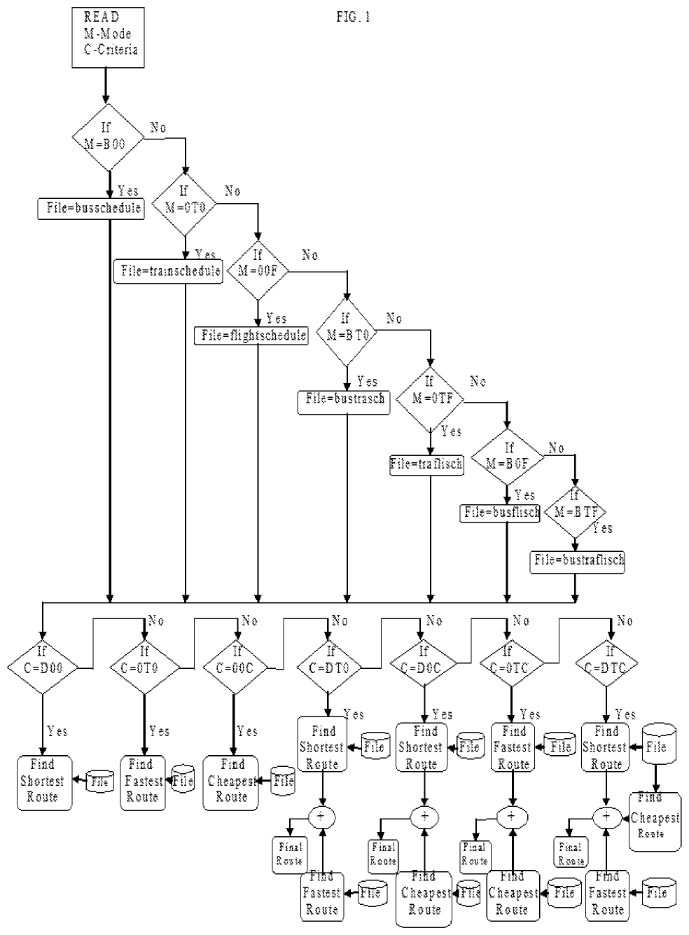

FIG. 1. From the input mode and criteria combinations first the mode or modes selection is done. Because the database files contains all records (source, destination, departure time, arrival time, number of available seats for the classes, vehicle number and the required minimum time in the stations for changing the vehicle (that depends on the size of the stations) of the particular single mode or multiple modes. For example, if the mode selection is for both bus and train (BT0), the database file contains all the information about all the trips of buses and trains. After that the input criteria combination is selected. According to those combinations the route is predicted. At last the transient routes derived for various criteria are combined together in percentage basis and the final route is formed. If the input is for one particular mode and criteria there is no need of percentage calculation of the final route.

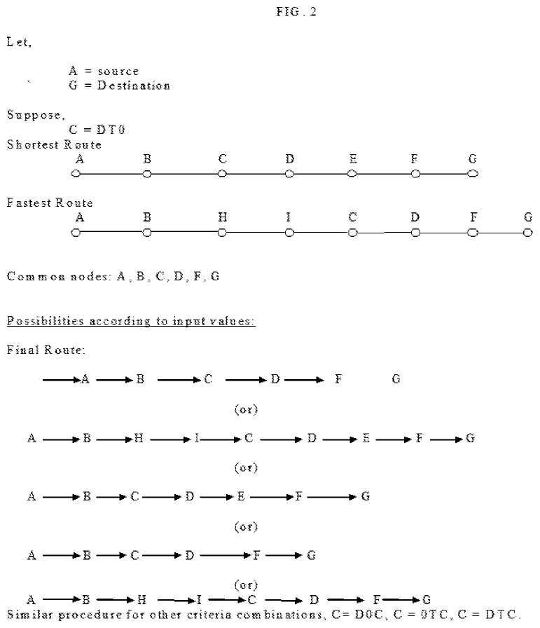

FIG. 2 is the step by step procedure to find the final route of criteria combinations.

Identify the common nodes between the routes of all required criteria.

Calculate the shortest distance or earliest time or cheapest cost (one by one which are all applicable) between all common nodes among the derived routes.

Assign that distance or time or cost as 100%.

Similarly find the percentage value of all the required criteria and its associated route between the adjacent common nodes.

Then calculate the sum percentage value of all the applicable criteria between all the common nodes.

Select the transient routes between all the common nodes from source to destination among the derived routes according to the percentage benefit. (Which one's sum value is low)

Find the distance, time and cost between the nodes of the final route from source to destination.

Calculate the total distance, duration and cost in the final route by adding the values between the nodes and display them.

For example,
Suppose ‘A’ and ‘B’ are the source and destination respectively and the criterion combination is “DT0”, that is only for shortest distance and fastest time.
Suppose the common nodes computed may be A, B, C, D, F, G,

Let the distance percentage in shortest route between all common nodes=100.

Time percentage in shortest route between all common nodes is calculated as below,

A, B=100

B, C=120

C, D=110

D, F=100

F, G=110

Let the time percentage in fastest route between all common nodes=100.

Distance percentage in fastest route between all common nodes is calculated as below,

A, B=100

B, C=130

C, D=100

D, F=105

F, G=112

Sum the percentage value in shortest route between all common nodes

A, B=100+100=200

B, C=100+120=220

C, D=100+110=210

D, F=100+100=200

F, G=100+110=210

Sum the percentage value in fastest route between all common nodes

A, B=100+100=200

B, C=100+130=230

C, D=100+100=200

D, F=105+100=205

F, G=112+100=212

Select the shortest route or fastest route between the common nodes, according to the value calculated in each routes. It is done by comparing the sum percentage values of respective node pairs among the route types. Suppose the criteria combination selection is “DTC”, the three percentage values according to each criteria (Distance, Time and Cost) will be added and the particular criteria route will be selected for each node pair as shown the above calculation.

According to that the final route computed is,

A---->B---->C---->D---->F---->G

A---->B in shortest route

B---->C in shortest route

C---->D in fastest route

D---->F in shortest route

F---->G in shortest route

The software core is written in Java language with the back end of Microsoft access data base. The developers may change the back end software and the connectivity method. The coding in the text file contains the software core in Java language. The sample database contains the details for few cities connected with the three modes bus, train and flight. That software core may be extended as a web design according to the end user requirement by involving suitable controls and the visual maps with appropriate animations. The database file may also be updated dynamically by connecting with the transport organizations database through by getting proper authorization. Otherwise offline maintenance of those files is also possible.

The size of the array variables in the software core and the size of the data base file may be determined by the developers according to the requirement of the number of stations and end users. This software core reads and computes the distance in miles, time in GMT and cost in US dollars. The updated data base file also accepts that format only. But it can be changed by the developers according to the requirement.

What is claimed is:

1. A traveling route solution method, program made up on percentage based conclusion of final unique route between the routes of three criterions distance, time and cost in a single software program.

2. The solution method, program for totally forty nine travel combination choices between seven combinations of three modes and seven criteria combinations of distance, time and cost.

3. The inbuilt method, program of ensuring the availability of required number of seats including the in between transient routes up to the destination for the required modes and criterions combinations.
